(19) United States
(12) Patent Application Publication
(10) Pub. No.: US 2007/0121018 A1
(43) Pub. Date: May 31, 2007

(54) Digital television with transfer function

(75) Inventors: Ching-Jou Chen, Taipei City (TW); Mao-Huan Huang, Taipei City (TW); Yen-Chih Su, Taipei City (TW)

Correspondence Address: BACON & THOMAS, PLLC, 625 SLATERS LANE, FOURTH FLOOR, ALEXANDRIA, VA, 22314, US

(73) Assignee: Tatung Company, Taipei City (TW)

(21) Appl. No.: 11/339,793

(22) Filed: Jan. 26, 2006

(30) Foreign Application Priority Data
Nov. 25, 2005 (TW) 094220507

(51) Int. Cl. H04N 5/44

(52) U.S. Cl. 348/725

(57) ABSTRACT

A digital television with transfer function, which includes a digital television tuner, a digital television controller, a command input device and an input/output connector. The digital television tuner receives a digital television signal and demodulates the signal received to thus produce a transport stream. The digital television controller having a decoder and an encoder receives the transport stream and uses the decoder to decode and convert the transport stream received into a decoded video data stream. The command input device receives an instruction. The input/output connector outputs or receives a video data stream. When the instruction received by the command input device is a video store output instruction, the encoder encodes the decoded video data stream, and the output connector outputs an encoded video data stream.

### BACKGROUND OF THE INVENTION

1. Field of the Invention

The invention relates to a digital television and, more particularly, to a digital television with transfer function.

2. Description of Related Art

A typical television can only receive and process video data, and display the video data processed on a screen. In order to record the video data in a multimedia computer, the typical television has to be connected with the multimedia computer. As shown in FIG. 1, the connection configuration includes a one-to-two video splitter 30, a television 10 and a multimedia computer 20. The television 10 and the multimedia computer 20 have the respective tuners 11 and 21.

The splitter 30 splits the video data into two parts, and one is received by the tuner 11 of the television 10 while the other is received by the tuner 21 of the multimedia computer 20. The television 10 uses a decoder 12 to process the data received and then displays the data processed on a screen 13. The multimedia computer 20 uses a CPU 22 to process the data received and then stores the data processed in a storage medium 23. The storage medium 23 can be a hard disk, CD-R, tape, or the like. The multimedia computer 20 can send the video data to the television 10 or other display 40 through a connection line. However, in the configuration of FIG. 1, the television 10 can only receive a single video data (namely, the video data either from the television 10 or the multimedia computer 20), which, in addition to the tuners 11 and 21 and the splitter 30, requires the operation of implementing the splitter 30 and associated lines, so as to increase the load to a user.

Therefore, it is desirable to provide an improved device to mitigate and/or obviate the aforementioned problems.

### SUMMARY OF THE INVENTION

An object of the invention is to provide a digital television with transfer function, which can store video data sent by the digital television without equipping a video storage with additional video data extractors such as a television card and a tuner.

Another object of the invention is to provide a digital television with transfer function, which can reduce the load to a user without the operation of implementing the splitter and associated lines.

According to a feature of the invention, a digital television with transfer function is provided. The digital television includes a digital television tuner, a digital television controller, a command input device and an input/output connector. The digital television tuner receives a digital television signal and demodulates the signal received to thus produce a transport stream. The digital television controller is connected to the digital television tuner and has a decoder and an encoder. The digital television controller receives the transport stream and uses the decoder to decode the transport stream received to thus output a decoded video data stream. The command input device is connected to the digital television controller in order to receive an instruction. The input/output connector is connected to the digital television controller in order to output an encoded video data stream or an external data. When the instruction received by the command input device is an video store output instruction, the encoder encodes the decoded video data stream to obtain the encoded video data stream, and the output connector outputs the encoded video data stream.

Other objects, advantages, and novel features of the invention will become more apparent from the following detailed description when taken in conjunction with the accompanying drawings.

### BRIEF DESCRIPTION OF THE DRAWINGS

FIG. 1 is a schematic diagram of connection of a typical television and a multimedia computer;

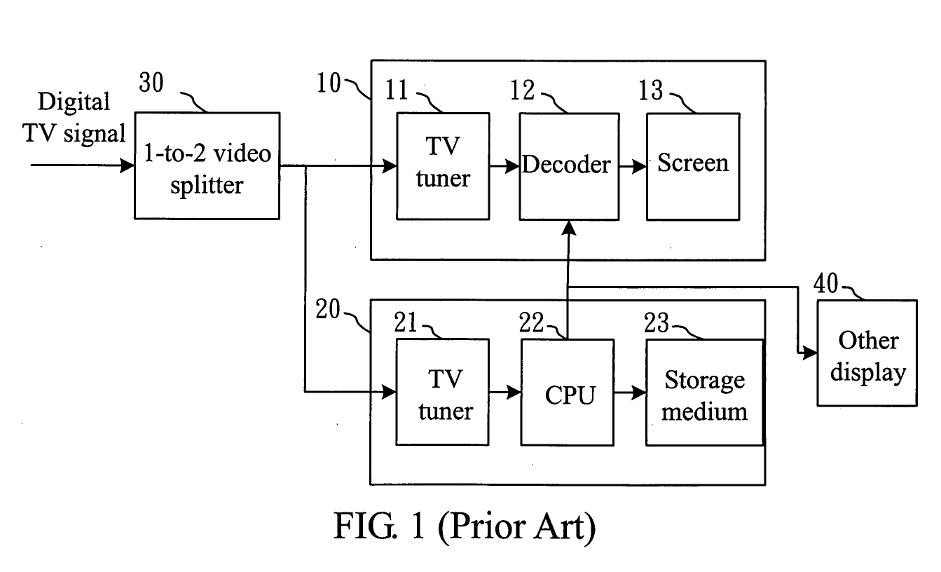

FIG. 2 is a block diagram of a digital television with transfer function according to the invention; and

FIG. 3 is a schematic diagram of connection of a digital television with transfer function and a multimedia computer according to the invention.

### DETAILED DESCRIPTION OF THE PREFERRED EMBODIMENT

In this embodiment, a digital television with transfer function is provided, which uses buttons on a panel or an infrared remote control to encode video data stream when an video store output instruction is entered, and uses an input/output connector to output the video data stream encoded.

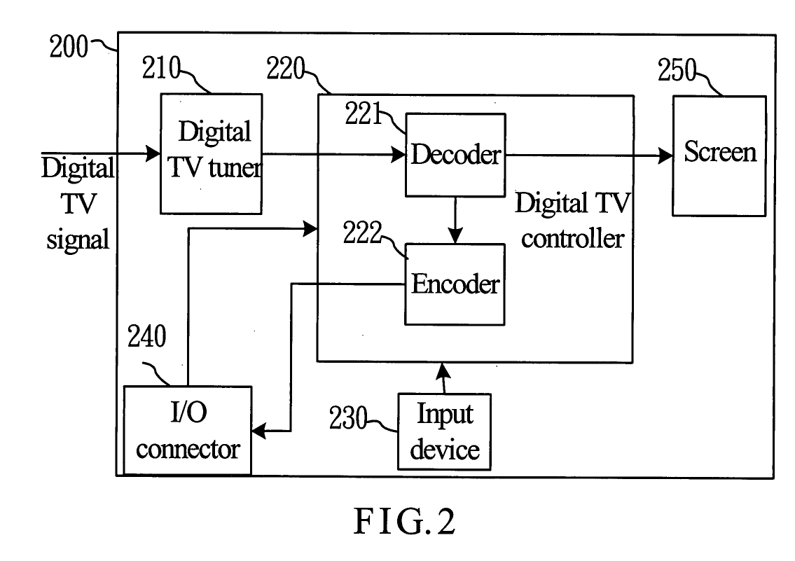

FIG. 2 is a block diagram of a digital television 200 with transfer function according to the invention. As shown in FIG. 2, the digital television 200 includes a digital television tuner 210, a digital television controller 220, a command input device 230, an input/output connector 240 and a screen 250.

The digital television tuner 210 receives a digital television signal for demodulation and thus produces a transport stream. The transport stream can be an MPEG2, MPEG4 or H.264 transport stream.

The digital television controller 220 is connected to the digital television tuner 210. The digital television controller 220 has a decoder 221 and an encoder 222. The digital television controller 220 receives the transport stream and decodes the received stream through the decoder 221 to thus output a decoded video data stream. The screen 250 is connected to the digital television controller 220 to thereby display the decoded video data stream. The screen 250 can be an LCD panel or a CRT.

The command input device 230 is connected to the digital television controller 220 in order to receive an instruction. The command input device 230 can be buttons implemented on a panel of the digital television 200, or an infrared receiver to receive an instruction sent by an infrared remote controller.

The input/output connector 240 is connected to the digital television controller 220 in order to output or receive a video data stream. The input/output connector 240 can be an Ethernet, USB, IEEE-1394, Wi-Fi transceiver.

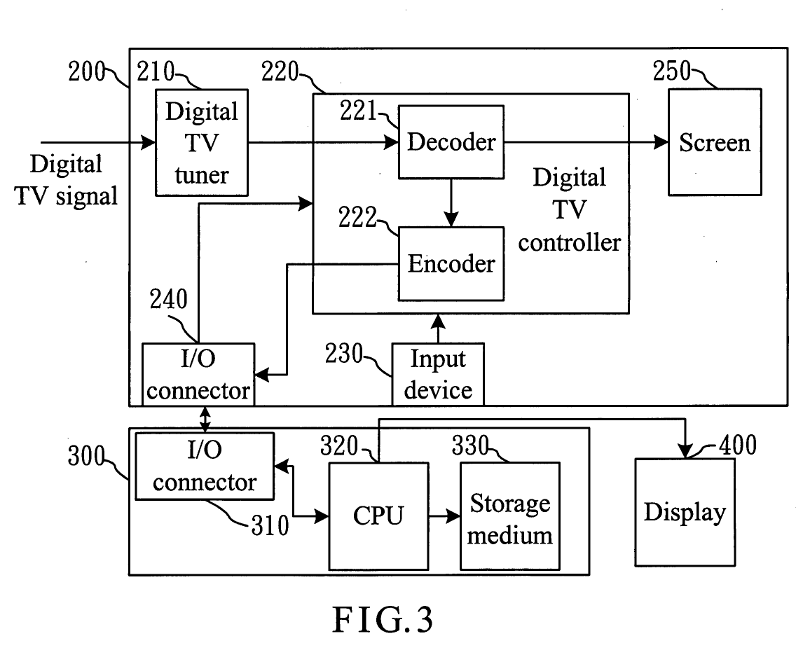

FIG. 3 is a schematic diagram of connection of the digital television 200 with transfer function and a multimedia computer 300 according to the invention. As shown in FIG. 3, the multimedia computer 300 uses its input/output connector 310 to connect the input/output connector 240 of the digital television 200 to thereby form a communication channel for receiving an encoded video data stream output by the digital television controller 220.

When the input/output connector 240 is an Ethernet, USB, IEEE-1394 or Wi-Fi transceiver, the input/output connector 310 is an Ethernet card or chip, a USB transceiver chip, an IEEE-1394 transceiver chip, or a Wi-Fi transceiver chip respectively.

When a user wants to record a received television program, the user can send avideo store output instruction through the buttons on the panel or an infrared remote control. The command input device 230 sends the video store output instruction to the digital television controller 220. The digital television controller 220 uses the encoder 222 to encode the decoded video data stream output by the decoder 221, and uses the input/output connector 240 to output the encoded video data stream.

The multimedia computer 300 receives the encoded video data stream through the input/output connector 310. The CPU 320 processes the encoded video data stream and converts it into avideo file in a storable format. The video file corresponding to the encoded video data stream is stored in the storage medium 330.

When the multimedia computer 300 is to play the video file stored in the storage medium 330, the CPU 320 reads the video file out of the storage medium 330 and encodes it into a receivable format by the digital television 200. The video file after encoded into the receivable format is output to the digital television 200 through the input/output connector 310 for playing on the screen 250.

As cited, the inventive digital television with transfer function can receive and process the video data, and display the video data processed on the screen. In addition, the video data can be sent to an video recorder through the input/output connector Display, which can save the additional cost of implementing a television card or tuner in an video storage equipment and simplify the system configuration without the operation of implementing the one-to-two video splitter and associated lines.

Although the present invention has been explained in relation to its preferred embodiment, it is to be understood that many other possible modifications and variations can be made without departing from the spirit and scope of the invention as hereinafter claimed.

What is claimed is:

1. A digital television with transfer function, comprising:
a digital television tuner, which receives and demodulates a digital television signal to thus produce a transport stream;
a digital television controller, which is connected to the digital television tuner and has a decoder and an encoder such that the digital television controller receives the transport stream and uses the decoder to decode the transport stream received to thus output a decoded video data stream;
a command input device, which is connected to the digital television controller in order to receive an instruction; and
an input/output connector, which is connected to the digital television controller in order to output an encoded video data stream;
wherein when the instruction received by the command input device is an video store output instruction, the encoder encodes the decoded video data stream to obtain the encoded video data stream, and the output connector outputs the encoded video data stream.

2. The digital television as claimed in claim 1, further comprising a screen connected to the digital television controller for displaying the decoded video data stream.

3. The digital television as claimed in claim 1, wherein the command input device is buttons implemented on a panel.

4. The digital television as claimed in claim 1, wherein the command input device is an infrared receiver to receive an instruction sent by an infrared remote controller.

5. The digital television as claimed in claim 1, wherein the transport stream is an MPEG2 transport stream.

6. The digital television as claimed in claim 1, wherein the transport stream is an MPEG4 transport stream.

7. The digital television as claimed in claim 1, wherein the transport stream is an H.264 transport stream.
